(19) United States
(12) Patent Application Publication
(10) Pub. No.: US 2013/0304764 A1
(43) Pub. Date: Nov. 14, 2013

(54) METHOD AND APPARATUS FOR PROVIDING FILE ACCESS USING APPLICATION-PRIVATE STORAGE

(71) Applicants: Nadarajah Asokan, Espoo (FI); Markus Juhani Miettinen, Saint-Sulpice (CH); Marcin Nagy, Helsinki (FI)

(72) Inventors: Nadarajah Asokan, Espoo (FI); Markus Juhani Miettinen, Saint-Sulpice (CH); Marcin Nagy, Helsinki (FI)

(73) Assignee: Nokia Corporation, Espoo (FI)

(21) Appl. No.: 13/468,598

(22) Filed: May 10, 2012

(51) Int. Cl. G06F 17/30; G06F 15/16

(52) U.S. Cl. 707/784; 707/E17.005

(57) ABSTRACT

An approach is provided for determining one or more social networks. A processor may then process and/or facilitate a processing of access information associated with one or more files, wherein access to the one or more files is based, at least in part, on the one or more social networks.

### BACKGROUND

Service providers and device manufacturers (e.g., wireless, cellular, etc.) are continually challenged to deliver value and convenience to consumers by, for example, providing compelling network services. One area of interest has been the development of secure file sharing. For example, key management in security schemes are increasingly advanced. However, security schemes often fail because their key management is hard to use, administer, and/or expensive to deploy. Simultaneously, many systems or services that enable creation of user accounts (e.g., social networks, online storage services, local file/operating systems, etc.) are often used as an organized way to convey files, but file sharing via such systems (e.g., social networks) often lacks security. For example, in such systems, users authorize applications for access to files in a coarse-grained manner: e.g., they can grant an application access to all groups of files or none; they cannot specify that some applications can access some groups only. As a result, service providers and device manufacturers face significant technical challenges to enabling efficient and flexible enforcement of file access security by users and/or applications.

### Some Example Embodiments

Therefore, there is a need for an approach for secure file distribution via user-account based systems so that access to the files can be limited to a subset of users of such user-account based systems as well as to a limited set of applications.

According to one embodiment, a method comprises determining one or more user account-based systems (e.g., one or more social networks with accounts for individual users). The method also comprises processing and/or facilitating a processing of access information associated with one or more files, wherein access to the one or more files is based, at least in part, on the one or more user account-based systems.

According to another embodiment, an apparatus comprises at least one processor, and at least one memory including computer program code for one or more computer programs, the at least one memory and the computer program code configured to, with the at least one processor, cause, at least in part, the apparatus to determine one or more one or more user account-based systems. The apparatus is also caused to process and/or facilitate a processing of access information associated with one or more files, wherein access to the one or more files is based, at least in part, on the one or more one or more user account-based systems.

According to another embodiment, a computer-readable storage medium carries one or more sequences of one or more instructions which, when executed by one or more processors, cause, at least in part, an apparatus to determine one or more one or more user account-based systems. The apparatus is also caused to process and/or facilitate a processing of access information associated with one or more files, wherein access to the one or more files is based, at least in part, on the one or more one or more user account-based systems.

According to another embodiment, an apparatus comprises means for determining one or more one or more user account-based systems. The apparatus also comprises means for processing and/or facilitating a processing of access information associated with one or more files, wherein access to the one or more files is based, at least in part, on the one or more one or more user account-based systems.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of secure file distribution via user account-based systems, according to one embodiment;

FIG. 2 is a diagram of the components of the authentication platform that permits access to secure files, according to one embodiment;

FIG. 3 is a flowchart of a process for ensuring secure file distribution via user account-based systems, according to one embodiment;

FIG. 4 is a flowchart of a process for constructing application-specific file repositories, according to one embodiment;

FIGS. 5A-5B are diagrams of secure file storage and retrieval on a user account-based system using the process of FIG. 3, according to one embodiment.

FIGS. 6A-6B are diagrams of storage and retrieval of data through layers of security for data stored on a user account-based system using the process of FIG. 3, according to one embodiment.

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for secure file distribution in user account-based systems are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used in the various embodiments described herein, the term “user account-based systems” refers to any service, application, operating system, file system, or other system that provides the capability to create user accounts. For example, social networks or social networking services provide the capability for users to create individual accounts and then specify social graphs, or other social relationship information for individual users. The user accounts, for instance, may be secured using one or more authentication schemes (e.g., username/password, authentication secrets, etc.). Other examples of user account-based systems include cloud storage services, email services, and the like. In addition, although the various embodiments are described with respect to social networks or social networking services as a type of user account-based system, it is contemplated that the approach described in the various embodiments are applicable to any type of user account-based systems including network-based systems and local systems (e.g., local file systems, operating systems, etc. with user account capability). In addition, the user account-based systems need not provide social graph or relationship information under the various embodiments described herein.

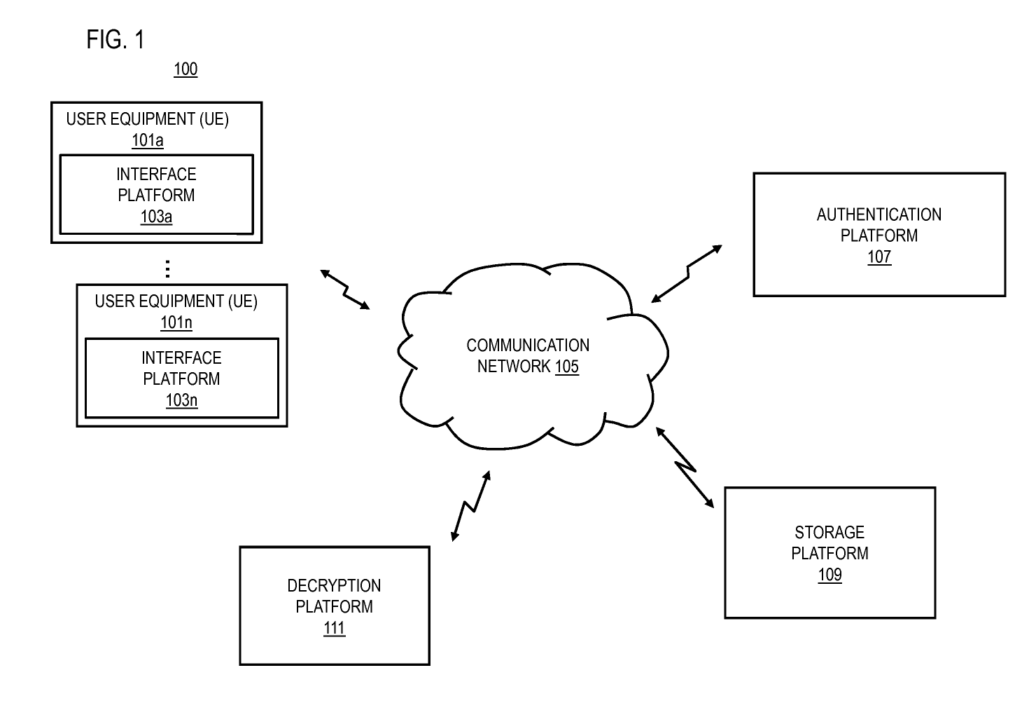

FIG. 1 is a diagram of a system capable of secure file distribution via user account-based systems (e.g., social networks), according to one embodiment. Service providers and device manufacturers (e.g., wireless, cellular, etc.) are continually challenged to deliver value and convenience to consumers by, for example, providing compelling network services. One area of interest has been the development of secure file sharing, specifically, by improving key management in security schemes. Present security schemes often fail because their key management is hard to use, administer, and/or expensive to deploy. Simultaneously, user account based-systems (e.g., social networks) are often used as an organized way to convey files, but file sharing via social networks currently often lacks security. In many authentication methods, users authorize applications in a coarse-grained manner: e.g., they can grant an application access to all groups or none; they cannot specify that some applications can access some groups only. Requiring more fine-grained access control can be too burdensome for the users. Consequently, there may be no way to share secure information among selected subsets of a user's social graph or users of user account-based systems because a user may inadvertently grant a rogue application access to this information.

To address this problem, a system 100 of FIG. 1 introduces the capability to securely distribute files by storing one or more files in one or more application-specific file repositories accessible by user authentication. In this way, the one or more files may be secure since the one or more files are accessible only to a specified group of users and only using a specified application. Such file saving entails two types of authentications: a user authentication and an application authentication. In one embodiment, the user authentication may be distributed using features from user account-based systems such as social networks. The application authentication may take place using a variety of methods. In one instance, the user account-based system may perform application authentication (e.g. Facebook application authentication). In another example, application authentication may be remote application authentication. Remote application authentication may exist for on-device applications (e.g. Windows Phone applications or Symbian applications), where the platform security system on a device will authenticate an application, then convey this fact to the remote server that hosts the application-specific storage repository.

In the system 100, there is the capability to securely share data using two components: application authentication and application-specific storage repositories. By way of example, application authentication is a mechanism in social networks or other user account-based systems to ensure that only authorized applications are able to access information the networks or systems. Similarly for on-device applications, there may be a procedure where a trusted platform on a device proves statements about entities on a device to a designated (remote) verifier. Regarding application-specific storage repositories, the purpose is to provide storage associated with an application that is guaranteed to be inaccessible by any other application. In one embodiment, the repositories may be on remote servers. In one embodiment, the platform provides the guarantee that the repository is accessible to one application, and one application only. Providing such isolated repositories may prevent applications from gaining access to private data or files without express consent from a user or device.

In one embodiment, each application associated with a user account-based system (e.g., social network), has its own file repository that is inaccessible to other applications, enforced by the system or social network itself. In one instance, for an on-device application, the device platform may provide application authentication towards a remote server. The remote server may then supply a separate private repository for each on-device application. In another example, such repositories are available only for a subset of all the applications associated with a system or on a device.

In one embodiment, each application may have equivalent applications across various platforms. For instance, there may be platform-specific adaptations of the same application for different operating systems or device platforms. For this situation, one repository may correspond to each of the equivalent applications. In one embodiment, each application version for each platform may have its own associated repository. To execute this, the files may be encrypted with an access key. A given group of the social network may then share the associated ciphertext. For instance, the group may share the ciphertext on the wall of the group. In this way, the ciphertext is accessible to all the applications. For each of the equivalent applications then, there may be a private repository on the social network server, and the access key may be stored on that private repository. Should any of these equivalent applications want to access the encrypted files, the application may retrieve the ciphertext from the wall of the group and the related access key from the repository to decrypt the ciphertext.

In another embodiment, there may be more fine-grained access to private data files within a system group (e.g., social network group) by encrypting data with several keys, distributed in different applications. For instance, data may be encrypted with more than one key, to produce a resulting ciphertext stored on the system or social network group. Each key may be stored on a different application, such that keys have to be retrieved from multiple applications before the ciphertext may be decrypted. For example, all the information associated for a theatre production may be stored on the theatre production group's group page on a system or social network. Members of the group include all the performers and backstage members of the theatre troupe, as well as fans of the theatre troupe. Everyone that is part of the group's page on the social network may access the troupe's performing times. Authentication for access to those files require only one key (from one application) to decrypt. Performers of the troupe may access rehearsal schedules, that require two keys (from two applications) to decrypt. Managers of the troupe access the troupe's financial information, requiring three keys (from three applications and thus three corresponding application-specific repositories) to decrypt the data. This way, the system 100 may provide more sensitive access or security to data shared within a social network group.

As shown in FIG. 1, the system 100 comprises a user equipment (UE) 101 (or UEs 101a-101n) having connectivity to an interface platform 103 (or interface platforms 103a-103n), an authentication platform 107, a storage platform 109, and a decryption platform 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the interface platforms 103 may interact with the authentication platform 107 and storage platform 109, to generate user interfaces for selection of applications and/or access to social network group pages. The authentication platform 107 and storage platform 109 may receive, from the interface platforms 103, user input regarding which files to access and whether the user may access the files. In one embodiment, the authentication platform 107 may determine authentications from the social networks and applications. Furthermore, the authentication platform 107 may retrieve, from the storage platform 109, access keys with which to decrypt files. In a further embodiment, the authentication platform 107 may also detect when multiple keys are required to access files and determine the applications needed to retrieve the keys. The authentication platform 107 may also process and/or facilitate a processing of the authentication needed, and receive the keys from repositories associated with applications.

In one embodiment, the storage platform 109 may store data files and/or the repositories associated with each of the applications. In a further embodiment, the storage platform 109 may contain the access keys for the files stored. In an even further embodiment, the storage platform 109 may encrypt the data files. For such a scenario, the UEs 101 may work with the storage platform 109 such that the ciphertext of the files are shared on social network groups. In one embodiment, the decryption platform 111 may receive the encrypted files from the storage platform 109 and access keys from the authentication platform 107 to decrypt the files. The decryption platform 111 may further work with the interface platforms 103 to give users access to the decrypted files.

By way of example, the UE 101, the interface platforms 103, authentication platform 107, storage platform 109, and decryption platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

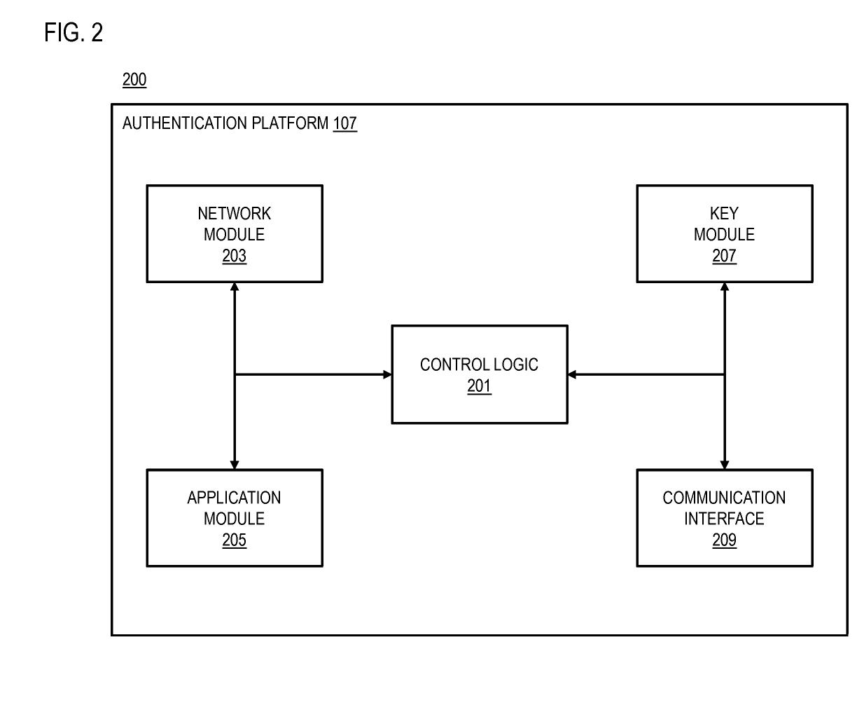

FIG. 2 is a diagram 200 of the components of the authentication platform 107, according to one embodiment. By way of example, the authentication platform 107 includes one or more components for providing secure file distribution in user account-based systems such as social networks. As previously discussed, authentication may be in two parts: user authentication and application authentication. It is contemplated that the functions of these components may be combined in one or more components or performed by other components of equivalent functionality. In this embodiment, the authentication platform 107 includes a control logic 201, network module 203, application module 205, key module 207, and communication interface 209. The control logic 201 executes at least one algorithm for executing functions at the authentication platform 107. For example, the control logic 201 may interact with the network module 203 to determine one or more user account-based systems (e.g., social networks) associated with one or more UEs 101. In one embodiment, the user account-based systems include, at least in part, one or more social networks of the one or more users, provide information to indicate one or more relationships among the one or more users, or a combination thereof. In other embodiments, the user account-based systems need not include information for indicating social graphs or social relationships for the users. From the user account-based systems or social networks, control logic 201 and key module 207 may determine metadata associated with one or more users in the one or more systems or social networks for user authentication. The key module 207 may then process and/or facilitate a processing of the metadata to authenticate one or more associated UEs 101 for access to one or more files.

In one embodiment, one or more systems or social networks may establish one or more groups of users as having access to one or more files. For instance, members of a wrestling group on a social network may have access to one or more files on competition schedules or training videos. The network module 203 may determine whether one or more UEs 101 are associated with the wrestling group, and grant access to one or more files based on the determination. In a further example, the wrestling group may share one or more authentications or authentication secrets within their group on the social network. In one embodiment, the term authentication broadly includes both the act of authenticating as well as the technical means and information (e.g., secrets) used during the act of authenticating. Then, the key module 207 may retrieve the authentication to permit members to access files shared within the group. In another further example, the one or more social networks may authenticate whether or not a member is old enough to access the training video files, due to considerations on the violent content. For such a case, the social network may contain metadata associated with users, such as age, that the key module 207 may use as authentication for access to files.

In another embodiment, the control logic 201 may work with the application module 205 to determine one or more applications that maintain files for members of one or more systems or social networks for application authentication. Once the application module 205 identifies the one or more applications, the key module 207 may determine a second authentication associated with the one or more applications in order to permit access to application-specific repositories. With the second authentication, the control logic 201 may trigger the decryption platform 111 to access files in the storage platform 109. In one embodiment, authentication may require the key module 207 to acquire one or more access keys. In some cases, as discussed thus far, the one or more access keys may come from the one or more social networks and/or the one or more application.

In a further case, one or more files may require various access keys to decrypt or access. For instance, for a club's group on a social network, executive board members may have access to files that other members do not. On top of that, co-presidents and treasurers of the club may have access to a further subset of group files. In such a scenario, the one or more applications (and their corresponding repositories) may include layers of access, each with their associated access keys such that the key module 207 must retrieve associated access keys to reach appropriate portions of the data repositories.

The control logic 201 may use the communication interface 209 to communicate with other components of the authentication platform 107, UEs 101, storage platform 109, decryption platform 111, and other components of the system 100. In one embodiment, the communication interface 209 may trigger the decryption platform 111 to use access keys found by the key module 207 to reach data files managed by the storage platform 109. In another embodiment, the control logic 201 may work with the communication interface 209 and interface platforms 103 to create various user interfaces. The communication interface 209 may include multiple means of communication. For example, the communication interface 209 may be able to communicate over SMS, internet protocol, or other types of communication.

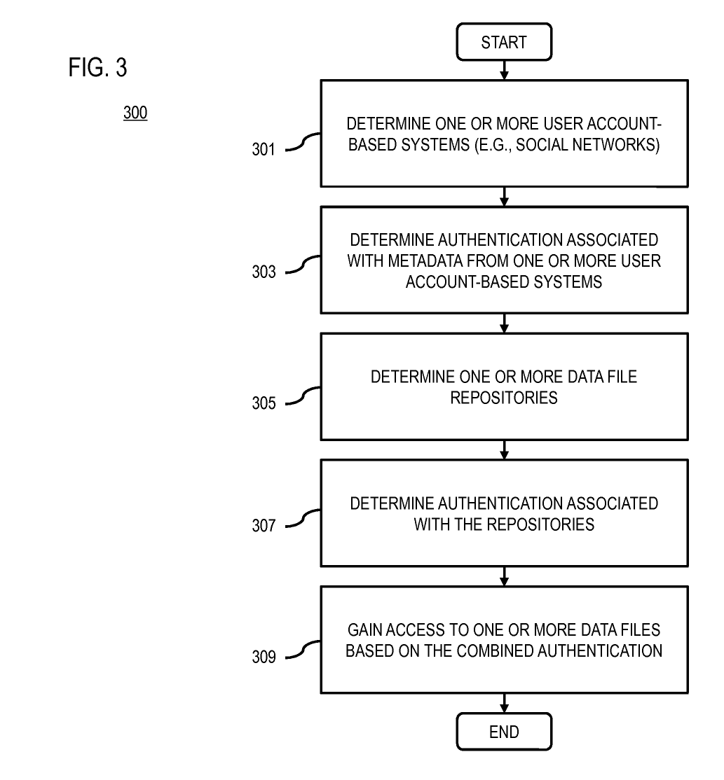

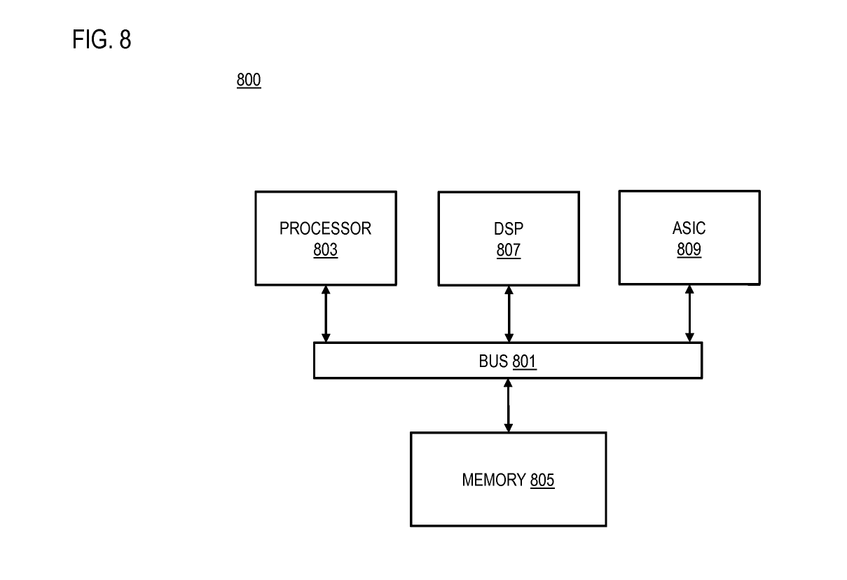

FIG. 3 is a flowchart of a process for ensuring secure file distribution via user account-based systems (e.g., social networks), according to one embodiment. In one embodiment, the authentication platform 107 performs the process 300 and is implemented in, for instance, a chip set including a processor and a memory as shown in FIG. 8. In step 301, the control logic 201 and network module 203 determine one or more user account-based systems (e.g., social networks) and process, and/or facilitate a processing of access information associated with one or more files. Processing access information may include processing and/or facilitating a processing of metadata associated with one or more users in the one or more systems or social networks, wherein access to the one or more files is based, at least in part, on the one or more systems or social networks. The control logic 201 and key module 207 may cause, at least in part, an authentication to be associated with the metadata, wherein access to one or more files is based, at least in part, on the metadata (step 303).

Then, for step 305, the control logic 201 and application module 205 may determine one or more file repositories. Given the one or more file repositories, the control logic 201 and key module 207 may determine a second authentication associated with the one or more file repositories (step 307), wherein access to one or more files is based, at least in part, on the second authentication. With the authentications, control logic 201 may permit access to the one or more files, wherein access to one or more files is based, at least in part on a combination of one or more authentications (step 309).

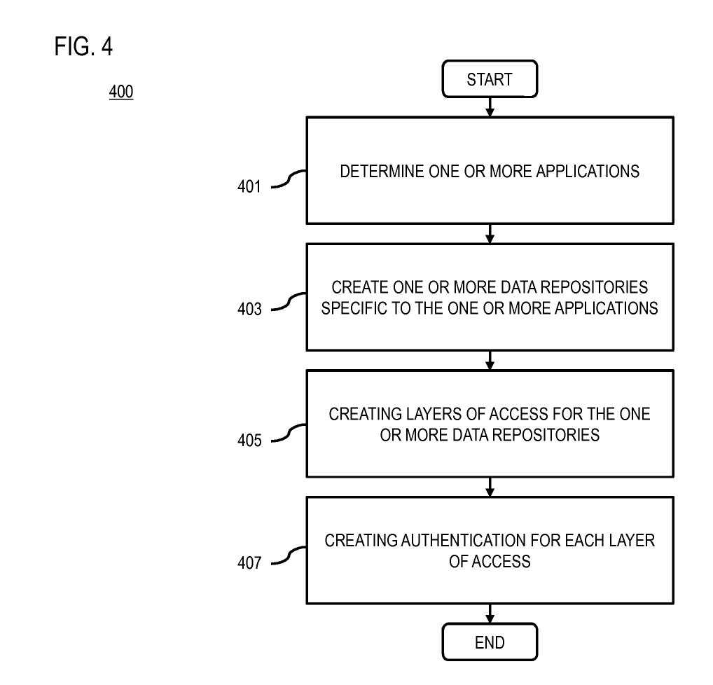

FIG. 4 is a flowchart of a process for constructing application-specific file repositories, according to one embodiment. In one embodiment, the authentication platform 107 performs the process 400 and is implemented in, for instance, a chip set including a processor and a memory as shown in FIG. 8. In step 401, the system 100 creates one or more data repositories, such as storage platform 109, wherein the one or more file repositories are associated with the one or more applications. For step 403, the system 100 may then determine one or more layers of access to one or more file repositories, wherein access to one or more files is based, at least in part, on the layer of access associated with one or more users. Next, the system 100 may determine an authentication for each of the one or more layers of access, causing, at least in part, an association of the authentication with each of the one or more layers of access (step 405). In one embodiment, authentication may include one or more decryption mechanisms. Lastly, the system 100 may create the one or more file repositories, wherein the one or more applications provide authentication associated with the one or more file repositories (step 407). In one embodiment, one or more applications provide the authentication associated with each of the one or more layers of access.

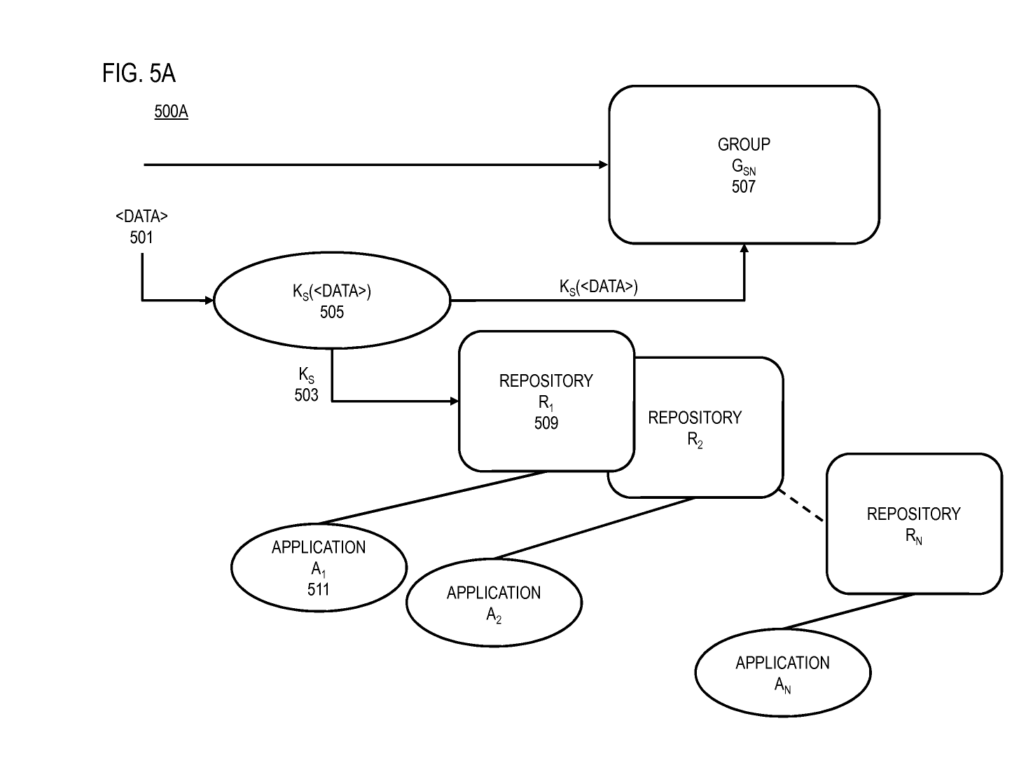

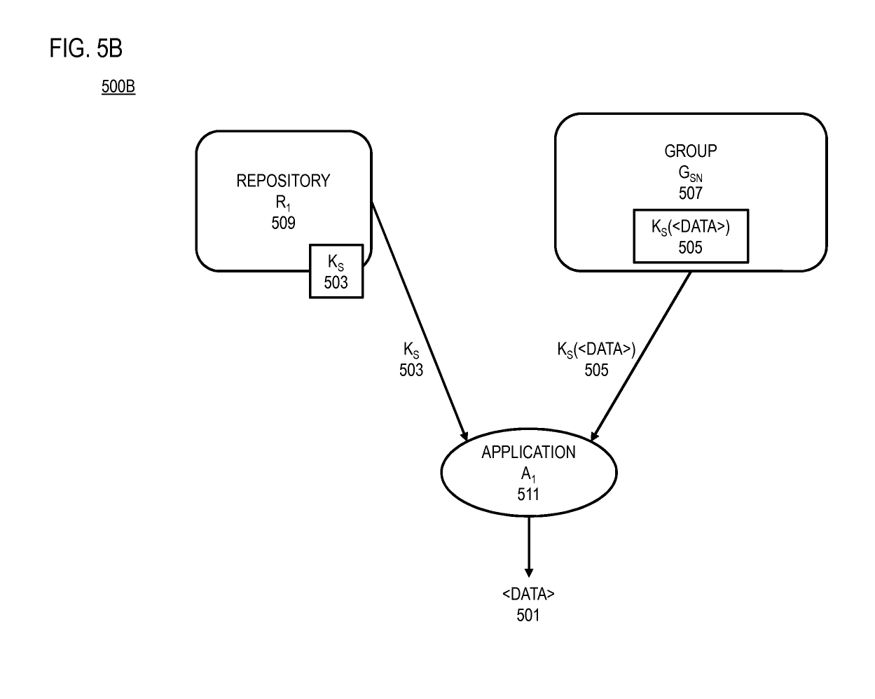

FIG. 5A is a diagram of how secure files may be stored on a user account-based system (e.g., a social network) using the process of FIG. 3, according to one embodiment. In one embodiment, one or more UEs 101 may use comparable applications to access files associated with one or more social networks. In one embodiment, comparable applications include applications that provide substantially similar functions as another. Comparable applications may include, for instance, one or more applications that are provided by different platforms to perform substantially the same or similar functions. For example, a first application by one developer may provide for microblogging to a particular social networking service, and a second application by another developer may provide the same for functions for the same social networking service. Accordingly, the first application and the second application would be comparable applications. Such a need may arise out of technical limitations or differences in UE 101 platforms, for example (e.g., when one application is not available for one platform or operating system, but a comparable application can be substituted for that platform or operating system). In one case, the system 100 may permit one or more comparable applications access to a single, secure data file repository. As shown in flowchart 500A, the storage platform 109 may encrypt files or data, such as <data> 501 with an access key Kₛ 503. The system 100 may then post ciphertext Kₛ (<data>) 505 to a private group on a social network G_{SN} 507, where the group is accessible to one or more specified applications. The system 100 may create, on the social network server, a data file repository (R_{N}) for each of the specified applications (A_{N}), such as R₁ 509 for A₁ 511. The system 100 may also store key Kₛ 503 in e.g. the application-specific repository R₁ 509.

FIG. 5B is a diagram of retrieving secure files stored on a user account-based system (e.g., a social network) using the process of FIG. 3, according to one embodiment. In one embodiment as shown in flowchart 500B, when a specified application A₁511 seeks to obtain the private file, authentication platform 107 may receive the ciphertext Kₛ (<data>) 505 from the social network G_{SN} 507 and the associated key Kₛ 503 from the repository R₁ 509 for the decryption platform 111. The decryption platform 111 may then decrypt the ciphertext for the resultant <data> 501. In a further embodiment, the application A₁ 511 may be a platform-specific adaptation of an application for a particular operating systems or device platforms. Each of the applications versions may have their own application-specific data file repositories for storing the common access key Kₛ 503, thus permitting the various versions of the application to work across different device platforms.

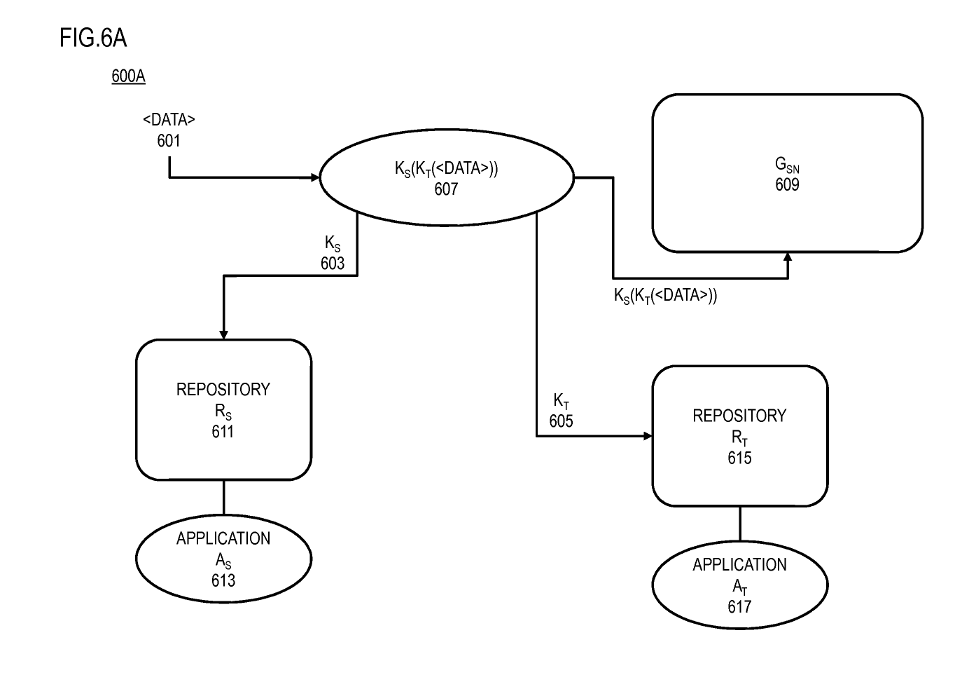

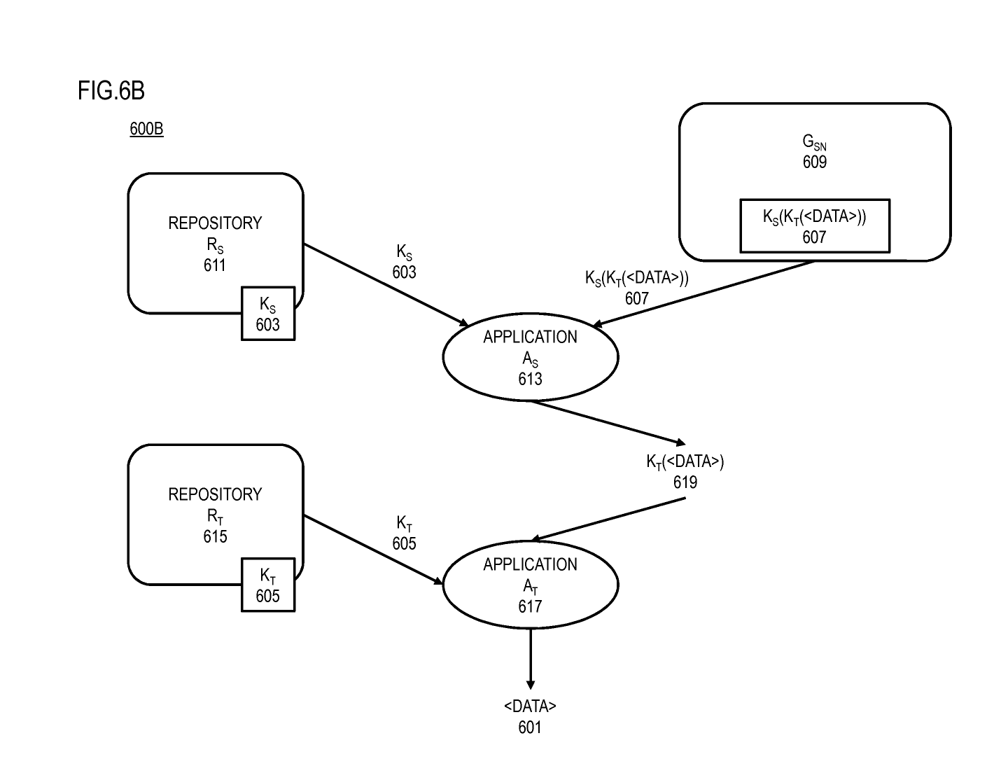

FIG. 6A is a diagram of layers of security for files stored on a user account-based system (e.g., a social network) using the process of FIG. 3, according to one embodiment. As previously discussed, the system 100 may further enable more fine-grained access to files within the group by encrypting some data with several different keys assigned to different applications. The more private the file, the more keys required to access the file. In one embodiment as in flowchart 600A, the storage platform 109 may encrypt data <data> 601 using two keys K_{S} 603 and K_{T} 605 to produce ciphertext K_{S}(K_{T}(<data>)) 607. The storage platform 109 may store the ciphertext K_{S}(K_{T}(<data>)) 607 on the social network group G_{SN} 609. In one example, the storage platform 109 may store the key K_{S} 603 in the repository R_{S} 611 of application A_{S} 613 and the key K_{T} 605 in the repository R_{T} 615 of application A_{T} 617.

FIG. 6B is a diagram of retrieving data at various secure levels that are stored on a user account-based system (e.g., a social network) using the process of FIG. 3, according to one embodiment. In one such embodiment shown by flowchart 600B, both applications A_{S} 613 and A_{T} 617 must be used to access one or more files. In other words, application A_{S} 613 may retrieve its access key K_{S} 603 from its repository R_{S} 611, while application A_{T} 617 retrieves its key K_{T} 605 from the corresponding repository R_{T} 615. Application A_{S} 613 may then retrieve the ciphertext K_{S}(K_{T}(<data>)) 607 from G_{SN} 609. The decryption platform 111 may then decrypt the ciphertext K_{S}(K_{T}(<data>)) 607 with key K_{S} 603 to retrieve ciphertext K_{T}(<data>) 619. The ciphertext K_{T}(<data>) 619 may then pass to application A_{T} 617, where application A_{T} 617 may use key K_{T} 605 to decrypt the ciphertext to retrieve the <data> 601.

In one embodiment, the applications authentication platform 107 may provide security features fᵢ. The set of security features that an application A provides with F_{A}={f₁, f₂, . . . , fₙ}. For instance, application A_{Identity}, may include the security feature set F_{Identity}={f_{Authenticated}_{_{—}}_{Identity}, f_{Authenticated}_{_{—}}_{Address}}, meaning that the application provides a verified identity and address information of the user of the application. In some scenarios, one or more user account-based systems or social networks may supply such verification. Additionally, verification may come from membership in one or more groups on the systems or social networks. For another example, application A_{Age} may provide the security feature set F_{Age}={f_{Age}_{_{—}}_{Verification}}, meaning that the application is capable of providing (possibly anonymous) age verification of the user of the application.

Thus, access to secret information in G_{SN} can be provided at two different levels: a basic level, that requires the application accessing the information to provide the authenticated identity of the user as a security feature, and an enhanced level, on which access is provided only, if the user's application setup provides both authenticated identity and age verification. This could be achieved as follows: the storage platform 109 may encrypt basic-level information with a key K_{Authenticated}_{_{—}}_{Identity}, where the key is stored in the application-specific repository associated with all applications that provide the security feature f_{Authenticated}_{_{—}}_{Identity}. As such, application A_{Identity} may also receive a copy of K_{Authenticated}_{_{—}}_{Identity} in its repository R_{Identity}.

Information on the enhanced level may be encrypted with two keys, K_{Authenticated}_{_{—}}_{Identity} and K_{Age}_{_{—}}_{Verification}. As follows from above, K_{Authenticated}_{_{—}}_{Identity} may be stored in R_{Identity} while K_{Age}_{_{—}}_{Verification} is stored in R_{Age}. Now, in order to obtain access to basic-level information in G_{SN}, a user's application setup needs only to contain application A_{Identity}, since it provides the security feature f_{Authenticated}_{_{—}}_{Identity} and therefore has access to the key K_{Authenticated}_{_{—}}_{Identity} which is required to decrypt the secret basic-level data in G_{SN}.

However, in order to obtain access to enhanced level information in G_{SN}, both applications A_{Identity} and A_{Age} may be required in the user's application setup, since both the keys K_{Authenticated}_{_{—}}_{Identity} and K_{Age}_{_{—}}_{Verification} may be required to decrypt the enhanced-level secret data. In one embodiment, a third application may combine the keys K_{Authenticated}_{_{—}}_{Identity} and K_{Age}_{_{—}}_{Verification} and decrypt the files of interest. In another embodiment, the second application, A_{Age} may automatically begin decryption once the second authentication, K_{Age}_{_{—}}_{Verification}, is achieved.

This discussion describes only a very simplistic usage scenario of the invention extension. The same approach utilizing different keys in various combinations can be used to extend the system to several different security levels. Tailored usage of different keys may create compartmentalization of the information in social networks groups.

The processes described herein for secure file distribution via social networks may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

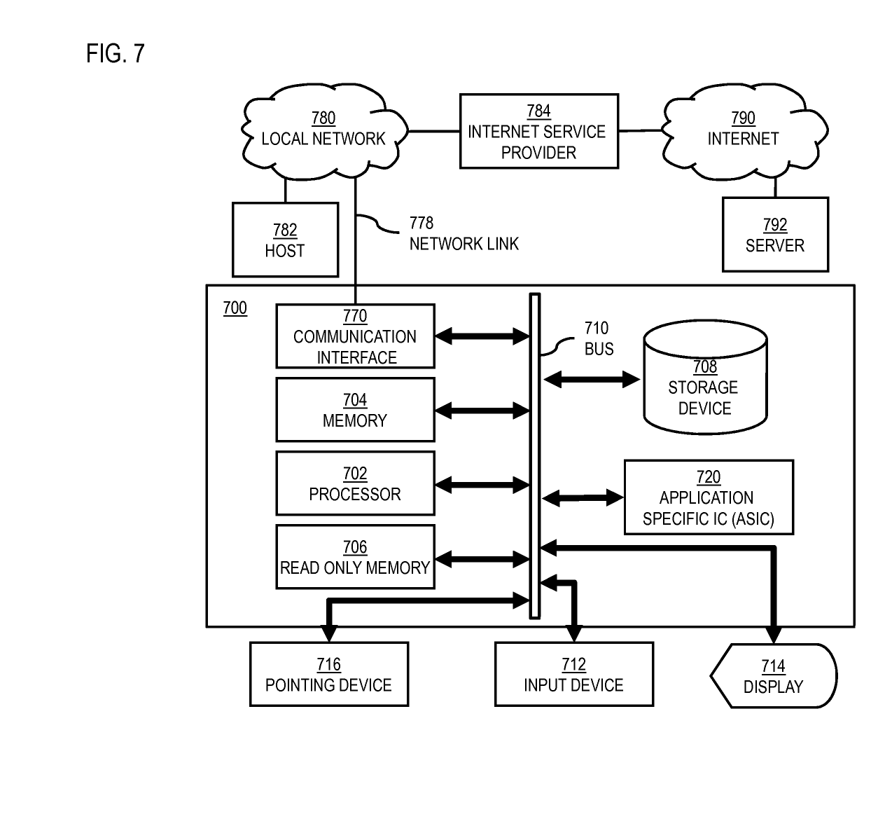

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to share items using audio as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of securely distributing files via social networks.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to secure file distribution via social networks. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for secure file distribution via social networks. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for secure file distribution via social networks, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for secure file distribution via social networks.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to share items using audio described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of secure file distribution via social networks.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to share items using audio. The memory 805 also stores the data associated with or generated by the execution of the inventive steps.

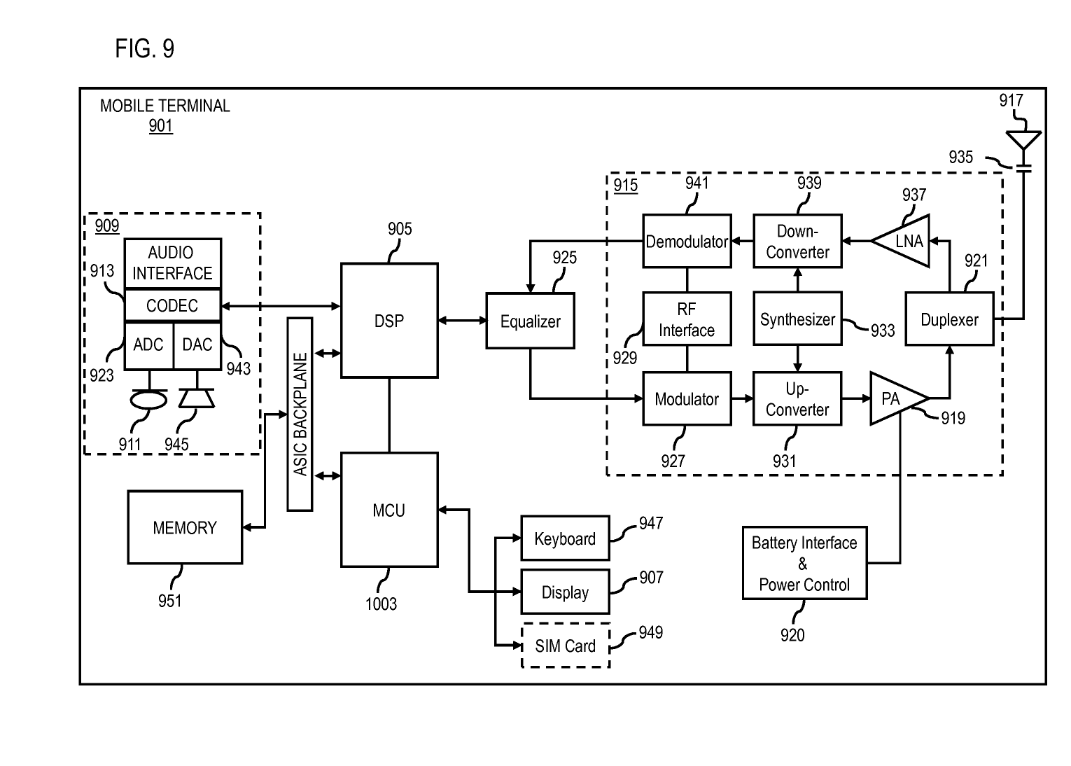

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of secure file distribution via social networks. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of secure file distribution via social networks. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to share items using audio. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more user account-based systems; and
a processing of access information associated with one or more files,
wherein an access to the one or more files is based, at least in part, on the one or more user account-based systems.

2. A method of claim 1, wherein the (1) data and/or (2) information and/or (3) at least one signal are further based, at least in part, on the following:
a processing of metadata associated with one or more users of the one or more user account-based systems; and
an authentication to be associated with the metadata,
wherein the access to one or more files is based, at least in part, on the metadata.

3. A method of claim 2, wherein the one or more user account-based systems include, at least in part, one or more social networks of the one or more users, provide information to indicate one or more relationships among the one or more users, or a combination thereof.

4. A method of claim 2, wherein the (1) data and/or (2) information and/or (3) at least one signal are further based, at least in part, on the following:
at least one determination of one or more file repositories; and
at least one determination of a second authentication associated with the one or more data file repositories,
wherein the access to one or more files is based, at least in part, on the second authentication.

5. A method of claim 4, wherein the one or more file repositories are associated with one or more applications, and wherein the one or more applications provide the authentication, the second authentication, or a combination thereof associated with the one or more file repositories.

6. A method of claim 5, wherein the one or more applications provide the authentication, the second authentication, or a combination associated with the one or more file repositories.

7. A method of claim 4, wherein the (1) data and/or (2) information and/or (3) at least one signal are further based, at least in part, on the following:
at least one determination of one or more layers of access to the one or more file repositories,
wherein the access to one or more files is based, at least in part, on the one or more layers of access associated with the one or more users.

8. A method of claim 7, wherein the (1) data and/or (2) information and/or (3) at least one signal are further based, at least in part, on the following:
at least one determination of an authentication the one or more layers of access; and
causing, at least in part, an association of the authentication with respective ones of the one or more layers of access.

9. A method of claim 8, wherein one or more applications provide the authentication associated with each of the one or more layers of access.

10. A method of claim 2, wherein the authentication includes one or more decryption mechanisms.

11. An apparatus comprising:
at least one processor; and
at least one memory including computer program code for one or more programs,
the at least one memory and the computer program code configured to, with the at least one processor, cause the apparatus to perform at least the following,
determine one or more user account-based systems; and
process and/or facilitate a processing of access information associated with one or more files,
wherein an access to the one or more files is based, at least in part, on the one or more user account-based systems.

12. An apparatus of claim 11, wherein the apparatus is further caused to:
process and/or facilitate a processing of metadata associated with one or more users of the one or more user account-based systems; and
cause, at least in part, an authentication to be associated with the metadata,
wherein the access to one or more files is based, at least in part, on the metadata.

13. An apparatus of claim 12, wherein the one or more user account-based systems include, at least in part, one or more social networks of the one or more users, provide information to indicate one or more relationships among the one or more users, or a combination thereof.

14. An apparatus of claim 12, wherein the apparatus is further caused to:
determine one or more file repositories; and
determine a second authentication associated with the one or more data file repositories, wherein the access to one or more files is based, at least in part, on the second authentication.

15. An apparatus of claim 14, wherein the one or more file repositories are associated with one or more applications, and wherein the one or more applications provide the authentication, the second authentication, or a combination thereof associated with the one or more file repositories.

16. An apparatus of claim 15, wherein the one or more applications provide the authentication, the second authentication, or a combination associated with the one or more file repositories.

17. An apparatus of claim 14, wherein the apparatus is further caused to:
determine one or more layers of access to the one or more file repositories,
wherein the access to one or more files is based, at least in part, on the one or more layers of access associated with the one or more users.

18. An apparatus of claim 17, wherein the apparatus is further caused to:
determine an authentication the one or more layers of access; and
causing, at least in part, an association of the authentication with respective ones of the one or more layers of access.

19. An apparatus of claim 18, wherein one or more applications provide the authentication associated with each of the one or more layers of access.

20. An apparatus of claim 12, wherein the authentication includes one or more decryption mechanisms.

21-48. (canceled)
